(19) United States
(12) Patent Application Publication
(10) Pub. No.: US 2020/0309751 A1
(43) Pub. Date: Oct. 1, 2020

(54) AMMONIA DETECTION MATERIAL AND DETECTOR

(71) Applicant: TDK CORPORATION, Tokyo (JP)

(72) Inventors: Shogo SHINGAI, Tokyo (JP); Tomohiko KATO, Tokyo (JP)

(73) Assignee: TDK CORPORATION, Tokyo (JP)

(21) Appl. No.: 16/823,501

(22) Filed: Mar. 19, 2020

(30) Foreign Application Priority Data
Mar. 26, 2019 (JP) 2019-059410
Feb. 26, 2020 (JP) 2020-030782

(51) Int. Cl. G01N 31/22; G01N 21/78; C07F 15/06; C07F 15/04

(52) U.S. Cl. CPC G01N 31/223; C07F 15/04; C07F 15/06; G01N 21/783

(57) ABSTRACT

An ammonia detection material and a detector including the ammonia detection material are provided. The ammonia detection material is capable of detecting ammonia easily, sensitively, continuously and selectively. The ammonia detection material of the present invention is represented by general formula (1): M1ₓFe_{y}(Pyrazine)ₛ[Ni₁₋ₜM2ₜ(CN)₄]. zH₂O, wherein M1=Co, Cu; 0.6≤x≤1.05; 0≤y≤0.4; 0≤s≤1; M2=Pd, Pt; 0≤t<0.15; 0≤z≤6.

### BACKGROUND OF THE INVENTION

### Field of the Invention

The present disclosure relates to an ammonia detection material and a detector including the ammonia detection material.

Priority is claimed on Japanese Patent Application No. 2019-059410, filed Mar. 26, 2019 and Japanese Patent Application No. 2020-030782, filed Feb. 26, 2020, the contents of all which are incorporated herein by reference.

### Description of Related Art

Ammonia is produced by microorganisms decomposing amino acids during corrosion of animal foods, and smell of the corrosive gas is directly detected by the nose by ordinary consumers.

Ammonia is also found in urine and sweat. Concentrations of Ammonia increase in diseases such as pyelonephritis, cystitis, urethritis, and prostatitis. Thus, detection of ammonia in urine and sweat leads to early detection of these diseases.

As a method for detecting ammonia gas, there is a method using a semiconductor sensor described in Patent Document 1 and a method using a sheet carrying a pH detection material such as bromophenol blue described in Patent Document 2. However, in the methods disclosed in Patent Documents 1 and 2, there is a problem that since extraction and collection of gas are required and the pH is changed due to blood, ammonia gas cannot be measured selectively.

Further, as a method for simply confirming leakage gas such as a lithium ion secondary battery, it has been proposed to use a material which changes color by adsorbing leakage gas (Patent Document 3). However, the conventional material {Fe(Pyrazine)[Ni(CN)₄]} disclosed in Patent Document 3 has a problem in that gases other than ammonia are also detected.

[Patent Document 1] Japanese Unexamined Patent Application Publication No. 2003-215097

[Patent Document 2] Japanese Unexamined Patent Application Publication No. 2007-278926

[Patent Document 3] WO 2016/047232

### SUMMARY OF THE INVENTION

It is an object of the present disclosure to provide an ammonia detection material and a detector which can detect ammonia by color change simply, sensitively, continuously and selectively by using the metal complex and the detector containing the metal complex of the present invention.

The inventors of the present invention have intensively studied and found that the above object can be achieved by using a metal complex represented by general formula (1).

M1ₓFe_{y}(Pyrazine)ₛ[Ni₁₋ₜM2ₜ(CN)₄]zH₂O (1)

In general formula (1), M1=Co, Cu; 0.6≤x≤1.05; 0≤y≤0.4; 0≤s≤1; M2=Pd, Pt; 0≤t<0.15; 0≤z≤6.

That is, according to the present invention, the following are provided.

[1] The ammonia detection material is represented by general formula (1),

M1ₓFe_{y}(Pyrazine)ₛ[Ni₁₋ₜM2ₜ(CN)₄]zH₂O (1)

wherein M1=Co, Cu; 0.6≤x≤1.05; 0≤y≤0.4; 0≤s≤1; M2=Pd, Pt; 0≤t<0.15; 0≤z≤6.

[2] The ammonia detection material according to [1], which is represented by general formula (2),

Coₓ[Ni₁₋ₜM2ₜ(CN)₄].zH₂O (2)

wherein M2=Pd, Pt; 0.9≤x≤1.0; 0≤t<0.15; 0.5≤z<6.

[3] The ammonia detection material according to [1] or [2], wherein the ammonia detection material is a polygonal plate-shaped metal complex particle having a side length of 0.5 μm or more and has a thickness of 0.2 μm or more.

[4] A detector including the ammonia detection material described in any one of [1] to [3].

[5] The ammonia detection method, comprising detecting ammonia by using the ammonia detection material described in any one of [1] to [3].

According to the present disclosure, it is possible to provide an ammonia detection material and a detector which can detect ammonia easily, sensitively, continuously and selectively.

### BRIEF DESCRIPTION OF THE DRAWINGS

FIG. 1 is a schematic diagram illustrating the basic chemical structure of an ammonia detection material according to an embodiment of the present invention.

FIG. 2 is a schematic diagram illustrating the basic chemical structure of an ammonia detection material according to an embodiment of the present invention.

FIG. 3 is a scanning electron micrograph at a magnification of ×1,000 of the crystal form of the ammonia detection material A of Example 1.

FIG. 4 is a scanning electron micrograph at a magnification of ×10,000 of the crystal form of the ammonia detection material A of Example 1.

FIG. 5 is a scanning electron micrograph at a magnification of ×1,000 of the crystal form of the ammonia detection material E of Example 5.

FIG. 6 is a scanning electron micrograph at a magnification of ×10,000 of the crystal form of the ammonia detection material E of Example 5.

### DETAILED DESCRIPTION OF THE INVENTION

Embodiments of the present invention (embodiment) will be described in detail with reference to the drawings. The present invention is not limited by the contents described in the following embodiments.

(Ammonia Detection Material)

The ammonia detection material of the present embodiment is represented by general formula (1).

M1ₓFe_{y}(Pyrazine)ₛ[Ni₁₋ₜM2ₜ(CN)₄]zH₂O (1)

In formula (1), M1=Co, Cu (M1 is at least one selected from the group consisting of Co and Cu.); 0.6≤x≤1.05; 0≤y≤0.4; 0≤s≤1; M2=Pd, Pt (M2 is at least one selected from the group consisting of Pd and Pt.); 0≤t<0.15; and 0≤z≤6 are satisfied.

In formula (1), the preferable range of x+y satisfies 0.9≤x+y≤1.05.

Specific examples of the ammonia detection material represented by the above formula (1) include Co_{0.9}Fe_{0.1}[Ni(CN)₄].3.2H₂O which is synthesized in Example 8 described later, and is an ammonia detection material represented by in the formula (1), wherein M1=Co; x=0.9; y=0.1; s=0; t=0; and z=3.2 are satisfied. Another example is Coₓ[Ni₁₋ₜM2₁(CN)₄].zH₂O, which is synthesized in Example 9 described later, and is an ammonia detection material represented by formula (1) wherein M1=Co; x=0.8; y=0.2; s=0; t=0; and z=3.2 are satisfied.

The ammonia detection material of the present embodiment according to the above formula (1) is preferably represented by general formula (2).

Coₓ[Ni₁₋ₜM2ₜ(CN)₄].zH₂O (2)

In formula (2), 0.9≤x≤1.0; M2=Pd, Pt; 0≤t<0.15; and 0.5≤z<6 are satisfied.

Specific examples of the ammonia detection material represented by the formula (2) include Co[Ni(CN)₄] 2.7H₂O which is synthesized in Example 1 described later, and is an ammonia detection material represented by in the formula (2) wherein x=1, t=0, and z=2.7 are satisfied.

The ammonia detection material of the present embodiment according to the above formula (1) is preferably represented by general formula (3).

Coₓ(Pyrazine)ₛ[Ni₁₋ₜM2ₜ(CN)₄] (3)

In formula (3), 0.9≤x≤1.0; 0≤s≤1; M2=Pd, Pt; and 0≤t<0.15 are satisfied.

Examples of the ammonia detection material represented by the formula (3) include Co(Pyrazine)[Ni(CN)₄] which is synthesized in Example 2 described later, and is an ammonia detection material represented by the formula (3) wherein x=1; s=1; and t=0 are satisfied.

Since the conventional material for detecting ammonia gas also detects gases such as alcohol and acetone, ammonia gas cannot be detected selectively. However, by using the ammonia detection material represented by the above general formula (1), it is possible to selectively detect ammonia by utilizing, for example, a change in color from pink to yellow. By using the metal complex represented by general formula (1), ammonia is selectively adsorbed and the color of the metal complex is changed.

In the general formula (1), it is preferable that M1=Co; y=0; s=0; and 0.5≤z<6, and if the water composition is large (z=6), the reactivity may be poor.

Also, if there is little water (0≤z<0.5), it may become amorphous and become less reactive.

Further, in the above general formula (2), more preferably, 0.9≤x≤1.0; M2=Pd, Pt; 0≤t<0.15; 1.5≤z≤2.5. The ammonia detection material in this range has purple color before the adsorption of ammonia gas and changes to yellow color after the adsorption, so that the visibility becomes easier. Thus, ammonia can be detected in a short time.

Specific examples of the ammonia detection material include, for example, Co[Ni(CN)₄].2.5H₂O which is synthesized in Example 16 described later, and is an ammonia detection material represented by the formula (2) wherein x=1; t=0; and z=2.5 are satisfied.

(Structure of Ammonia Detection Material)

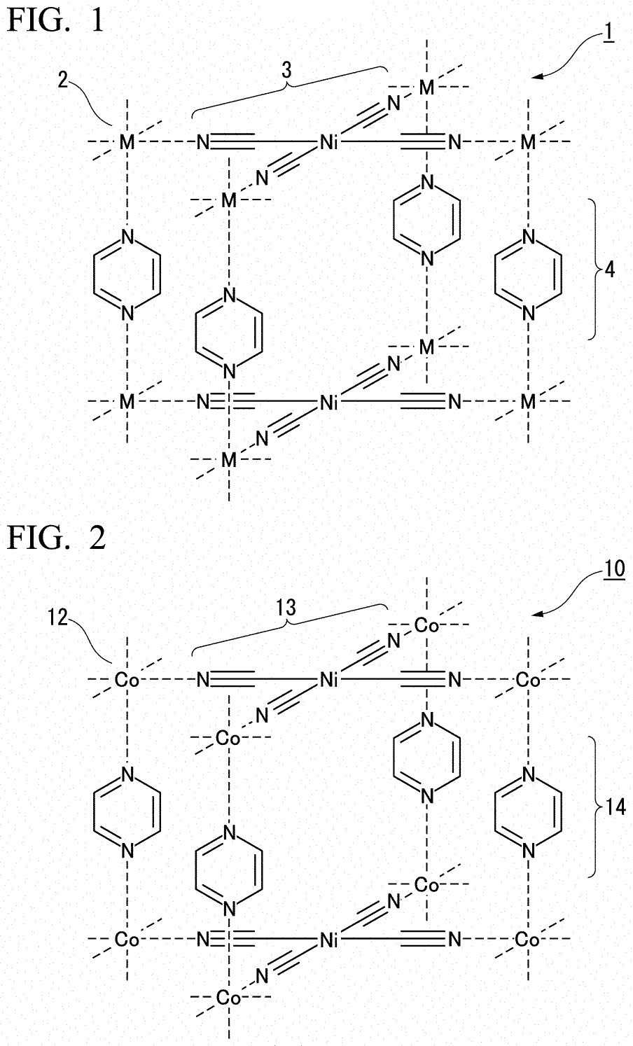

FIG. 1 is a schematic diagram showing a basic chemical structure of the ammonia detection material 1 of the present embodiment represented by the above general formula (1). In FIG. 1, the metal M ion 2 includes at least one selected from the group consisting of Co, Cu, and Fe. FIG. 2 is a schematic diagram showing a basic chemical structure of the ammonia detection material 10 represented by the above general formula (3), which is a preferred example of the ammonia detection material 1 of the present embodiment. Details will be described with reference to FIG. 2.

As shown in FIG. 2, the ammonia detection material 10 represented by the general formula (3) has a structure in which the tetracyanonickelate ion 13 and the pyrazine 14 are self-assembly and regularly coordinated onto the Co ion 12 and a jungle gym type skeleton is expanded, and the inner space can absorb varies of molecules or the like. In addition, a part of nickel can be replaced by at least one selected from palladium and platinum.

In the ammonia detection material 10, there is a phenomenon called spin crossover in which the electronic configuration of the Co ion 12 changes between two states which are called as a high-spin state and a low-spin state due to external stimulations such as heat, pressure, or adsorption of molecule. The spin change can be considered to be several tens of nanoseconds and is characterized by a very fast response speed.

The high spin state refers to a state in which the electrons are configured in a way that the spin angular momentum becomes the biggest according to the Hund's rule in seven orbitals of d electrons of Co ions in the complex. The low spin state refers to a state in which the electrons are configured in a way that the spin angular momentum becomes the smallest. Since the two states are different in the states of the electron and the distances in the lattice, the colors and the magnetisms of the complexes in the two states are different. That is, if the spin crossover phenomenon due to the adsorption of molecules to the ammonia detection material is used, it becomes possible to use the ammonia detection material as a detection material for quickly detecting a specific molecule.

The ammonia detection material in the high spin state is pink, and changes to yellow in the low spin state when it is sufficiently cooled by liquid nitrogen or the like. When exposed to the ammonia gas, the ammonia gas is adsorbed inside the crystal, and a low spin state is obtained. When the pink ammonia detection material in the high spin state is exposed to ammonia gas which induces the low spin state, ammonia gas is taken in the inside of the jungle gym type skeleton, and the yellow color in the low spin state seems to be obtained by the spin crossover phenomenon. That is, the ammonia detection material in the high spin state adsorbs ammonia gas in the presence of ammonia gas and changes to yellow in the low spin state. As described above, the detection material can be used by visually confirming the color tone, confirming the weight change of the ammonia gas adsorbed by the ammonia detection material, or analyzing the ammonia gas adsorbed inside the molecules of the ammonia detection material.

FIG. 2 shows, as a specific example, the ammonia detection material 10 represented by the general formula (3). However, an ammonia detection material 1 represented by the general formula (1), which is obtained by replacing other metal ions, for example, Cu ions or/and Fe ions at the position of Co ions 12, also shows a similar behavior.

The composition of the ammonia detection material of the present embodiment can be confirmed by using ICP emission spectroscopy, carbon sulfur analysis, oxygen nitrogen hydrogen analysis or the like.

The amount of H₂O contained in the metal complex of the present embodiment can be determined by confirming the mass number of the gas generated when the temperature is raised by using a gas chromatograph mass spectrometer equipped with a double-shot pyrolyzer and by confirming the weight reduction amount by thermogravimetric analysis.

The spin state of the ammonia detection material of the present embodiment can be confirmed by observing the response of magnetization relative to a magnetic field using a superconducting quantum interference magnetometer (SQUID) or a vibrating sample magnetometer (VSM).

(Crystal Particle of Ammonia Detection Material)

The crystal particle size of the ammonia detection material of the present embodiment is not particularly limited, but for example, it is a polygonal plate-shaped metal complex particle having a side length of 0.5 μm or more, and preferably has a thickness of 0.2 μm or more. When the length of one side is less than 0.5 μm and the thickness is less than 0.2 μm, the selectivity is maintained but the reactivity is poor and the color change when ammonia is detected tends to be slow. After ammonia detection, the color tends to easily return to the original color (Example 5).

The aspect ratio (ratio of long axis to short axis) of the particles is more preferably 1.0 to 2.0, still more preferably 1.0 to 1.2. When the aspect ratio is in the range of 1.0 to 2.0, the crystallinity of the ammonia detection material tends to be good, and the adsorptivity to ammonia becomes good (may have a longer holding time).

(Method for Manufacturing Ammonia Detection Material)

In the method for producing the ammonia detection material of the present embodiment, the ammonia detection material can be obtained by first reacting a divalent cobalt salt, copper salt and iron salt; an antioxidant; and a tetracyanonickanate, a tetracyanopalladate and a tetracyanoplatinate in a suitable solvent. If necessary, the obtained ammonia detection material is dispersed in a suitable solvent, and a precipitate is precipitated by adding pyrazine to the dispersion, and the precipitate is filtered and dried to obtain an ammonia detection material inactive to the pyrazine compound. By using an ammonia detection material which is inactive to the pyrazine compound, the ammonia gas can be selectively detected by color change even when the ammonia and the pyrazine compound coexist.

As the divalent cobalt salt, cobalt sulfate heptahydrate, cobalt chloride hexahydrate or the like can be used. As the divalent copper salt, copper sulfate pentahydrate, copper chloride dihydrate or the like can be used. As the divalent iron salt, iron sulfate heptahydrate, ammonium iron sulfate hexahydrate or the like can be used. As the antioxidant, L-ascorbic acid or the like can be used. As the tetracyanonickelate, potassium tetracyanonickelate hydrate or the like can be used. As the tetracyanopalladate, potassium tetracyanopalladate hydrate or the like can be used. As the tetracyanoplatinate, potassium tetracyanoplatinate-hydrate or the like can be used.

As the solvent, methanol, ethanol, propanol, water, or a mixed solvent thereof can be used.

(Detector)

The detector of the present invention includes an ammonia detection material represented by the above general formula (1). The detector of one embodiment of the present invention (hereinafter referred to as the detector of the present embodiment) includes, for example, the ammonia detection material of the present embodiment described above. The preferred ammonia detection material is the same as the preferred example of the ammonia detection material of the present embodiment.

A more specific detector of the present embodiment is typically an optical sensor, a resonant sensor, an electric resistance sensor, a magnetic sensor or the like. The optical sensor can detect the color change before and after the adsorption of the ammonia gas by visual observation or by a CCD camera. The resonance type sensor can detect the amount of adsorbed ammonia gas by capturing the amount of adsorbed ammonia gas as a change in the resonance frequency of the piezoelectric material for resonance driving. In the electric resistance type sensor, an ammonia detection material is carried between electrodes provided on a substrate, a voltage is applied between the electrodes, and an amount of adsorbed ammonia is detected as a change in electric resistance between the electrodes. In the magnetic sensor, an ammonia detection material is carried on a substrate, an AC magnetic field generator is arranged below the substrate, and a magnetic head is arranged above the substrate. The magnetic head converts magnetic flux generated from the AC magnetic field generator into voltage, and the adsorption amount of ammonia is detected as a change in voltage.

(Ammonia Detection Sheet)

A typical example of the detector according to the present embodiment is an ammonia detection sheet. The ammonia detection sheet includes a detection part on which the ammonia detection material is carried and a support. The ammonia detection sheet includes a support and the ammonia detection material of the present embodiment carried on the support.

At least a part of the ammonia detection material of the detection part is carried on a support through a binder described later. For example, when a pink ammonia detection material is used in a high spin state in a detection part, the ammonia detection material adsorbs the ammonia gas in the presence of the ammonia gas, and changes from pink to yellow. As described above, when the ammonia detection sheet of the present embodiment is used in the presence of ammonia gas, the presence of ammonia gas can be easily detected by visually confirming the difference in color tone between the detection unit and the color sample.

(Support)

The support used for the ammonia detection sheet of the present embodiment is not particularly limited as long as the ammonia detection material can be carried by using the binder.

As the support used for the ammonia detection sheet of the present embodiment, for example, a sheet-like fiber sheet made of fibers or the like is preferable. For example, a nonwoven fabric (including paper), a woven fabric, a knitted fabric or the like can be used as the fiber sheet.

It is preferable that the support used for the ammonia detection sheet of the present embodiment has a certain degree of opacity at least at a position where ammonia is detected (for example, a detection unit of the embodiment described below). In particular, when the support is a fiber sheet, the effect of the base color transmitted through the fiber sheet is reduced, and the visibility when the color of the ammonia detection material is changed by ammonia is enhanced. The opacity of the support can be evaluated by, for example, the opacity testing method of JIS P 8149: 2000. The opacity of the support used for the ammonia detection sheet of the present embodiment is preferably 50% or more, more preferably 70% or more, for example.

When the support used for the ammonia detection sheet of the present embodiment is a woven fabric or a knitted fabric, for example, a woven fabric or a knitted fabric composed of warps and wefts woven using one or more kinds of woven yarns (natural or artificial fibers) can be used.

The nonwoven fabric used for the support of the ammonia detection sheet of the present embodiment is a fiber sheet, web or bat in which fibers are unidirectionally or randomly oriented, and the fibers are bonded by entanglement and/or fusion and/or adhesion. The “nonwoven fabric” of the present invention includes paper but excludes woven fabric and knitted fabric.

When the support used for the ammonia detection sheet of the present embodiment is a nonwoven fabric, the fibers used as the raw material for the nonwoven fabric can be carbon fibers, glass fibers, metal fibers or the like; in addition to natural fibers, regenerated fibers of natural fibers, and organic chemical fibers. Among them, natural fibers, regenerated fibers of natural fibers and organic chemical fibers are preferable from the viewpoint of adhesion with the ammonia detection material. Two or more of these fibers can be used.

Natural fibers include cellulose pulp, cotton, hemp-like fibers (jute, sisal, hemp linen, ramie, or kenaf), silk, and wool fibers.

Examples of the regenerated natural fiber include rayon.

Examples of the material of the organic chemical fiber include a polyolefin resin, a (meta) acrylic resin, a vinyl chloride resin, a styrene resin, a polyester resin, a polyamide resin, a polycarbonate resin, a polyurethane resin, a thermoplastic elastomer, and a cellulose resin.

The polyester resin is preferably an aromatic polyester resin (polyethylene terephthalate (PET), polytrimethylene terephthalate, polybutylene terephthalate, polyethylene naphthalate, etc.), particularly a polyethylene terephthalate resin such as PET.

Aliphatic polyamides such as polyamide 6, polyamide 66, polyamide 610, polyamide 10, polyamide 12, polyamide 6-12 and their copolymers, and semi-aromatic polyamides synthesized from aromatic dicarboxylic acids and aliphatic diamines are preferable as the polyamide resin. These polyamide-based resins may also contain other copolymerizable units.

When the support used for the ammonia detection sheet of the present embodiment is a fiber sheet, the thickness (average thickness) of the fiber sheet is preferably 0.1 to 5 mm.

The fiber cross-sectional shape of the fiber sheet is not particularly limited, but may be a circular cross-sectional shape, an irregular cross-sectional shape, a hollow cross-sectional shape, or a composite cross-sectional shape. The modified cross-sectional shape may be any non-circular shape such as an elliptical shape, a triangular shape, a belt shape, a square shape, a polygonal shape, or a star shape.

The loading amount of the ammonia detection material on the ammonia detection sheet is preferably from 0.02 mg/cm² to 0.4 mg/cm². When the loading amount of ammonia detection material on the ammonia detection sheet is 0.02 mg/cm² or more, the color change when ammonia is adsorbed on the ammonia detection material becomes clear, and it is considered that it becomes difficult to be affected by the color of the support, the humidity of the atmosphere and the volatile organic compounds. When the loading amount of the ammonia detection material on the ammonia detection sheet is larger than 0.4 mg/cm², when detecting a small amount of ammonia, the color change tends to be indistinct due to the presence of the ammonia detection material that has changed color and the ammonia detection material that has not changed color.

(Binder)

The binder used in the ammonia detection sheet of the present embodiment is not particularly limited as long as the binder can support the ammonia detection material on the support and can maintain the adhesion between the support and the ammonia detection material. It can be selected appropriately according to the type of support used. From the viewpoint of high adhesion and ease of use, polymers or copolymers such as acrylic binders, styrene binders and butadiene binders can be used. Binders containing polymers can be used. Alternatively, a plurality of such binders may be used as a mixture.

(Binder Content)

The binder amount included in the ammonia detection sheet of the present embodiment is 4% by weight or more and 60% by weight or less with respect to the weight of the ammonia detection sheet. It is more preferable that the binder amount is 10% by weight or more and 40% by weight or less with respect to the weight of the ammonia detection sheet. When the amount of binder to the ammonia detection sheet weight is less than 4% by weight, the adhesion is weak, and when it is more than 60% by weight, the gas detection sensitivity tends to decrease.

The binder amount included in the ammonia detection sheet of the present embodiment includes, for example, the amount of the binder included in a commercially available support obtained as a raw material.

The amount of binder included in the ammonia detection sheet can be obtained by a Soxhlet extractor.

After storing the ammonia detection sheet in a desiccator at 25° C. and a humidity of 10% or less for 24 hours or more, the ammonia detection sheet is placed in an extraction tube. Using acetone as an extraction solvent, reflux is carried out for 24 hours using a heating device such as an oil bath or a mantle heater. The acetone extract thus obtained was concentrated using a rotary evaporator or the like. Thereafter, the amount of the binder is determined from the weight of the extract obtained by vacuum drying for 5 hours. The amount of binder contained in the ammonia detection sheet is obtained by calculating the weight ratio of the binder component to the weight of the ammonia detection sheet put in the extraction tube.

When using a support that partially dissolves in extraction solvent water, the binder amount may be obtained by determining the amount of elution into the water beforehand and subtracting the amount of the support elution into water from the weight of the binder component.

(Measurement of Loading Amount of Ammonia Detection Material on the Ammonia Detection Sheet)

The method of obtaining the loading amount of the ammonia detection material per area of the ammonia detection sheet of the present embodiment is as follows.

The loading amount of ammonia detection material is determined based on the average loading amount of Co element per area which was obtained by measuring 10 locations in the detection sheet where the ammonia detection material is supported, by using the thin-film Fundamental Parameter Methods of X-ray fluorescence analysis. The loading amount of Co element per area was obtained by measurement of using an equipment of ZSX100e manufactured by Rigaku Corporation at the condition that the measurement spot diameter is 3 mmΦ (5 mmΦ screw holder made from SUS), and by calculation of removing background difference based on the blank measurement value of the support. The loading amount of the ammonia detection material was calculated from the ratio of the amount of ammonia detection material with respect to the amount of Co element wherein the ratio was obtained by using composition analysis of the ammonia detection material.

Specific examples of the support used for the ammonia detection sheet of the present embodiment include, for example, cardboard (made by ADVANTEC, circular quantitative filter paper No. 5) made of cellulosic fibers, such as filter paper; non-woven fabric made of polyester fiber (FP6020, manufactured by Wintec); nonwoven fabric made of polypropylene fiber (FP7020, manufactured by Wintec); non-woven fabric made of rayon, polyethylene and polyester fibers (FP9010, manufactured by Wintec); woven fabric (product name: polished cloth; material: polyester, nylon) in which polyester and nylon fibers are combined vertically and horizontally; and fiber sheets (knitted fabrics) made by knitting the fibers of rayon dough.

(Method for Detecting Ammonia Gas)

The detector of the present embodiment provided with the ammonia detection sheet can detect the ammonia gas generated by the detection target, for example, by being disposed near the surface of the detection target. When the ammonia detection material contacts the ammonia gas, the ammonia gas is adsorbed in the molecule of the ammonia detection material, and at the same time, the electronic state changes from high spin to low spin and the color tone changes. Ammonia gas can be easily detected by visually comparing the color differences using a separately prepared color sample (For example, Standard Paint Color 2013 G, manufactured by the Japan Paint Manufacturers Association). Further, even if gases other than ammonia are generated, the ammonia detection material of the present embodiment does not adsorb these gases inside the molecule and the color tone does not change. Therefore, ammonia gas can be selectively detected.

As an example, the ammonia detection material of the present invention can be contained in the ammonia detection sheet of the present embodiment. The ammonia detection sheet of the present embodiment can contact the atmosphere of, for example, a storage container for animal food, and can be arranged at a place where the color change can be observed from the outside of the container. Animal foods are known to generate ammonia gas when decomposed by spoilage. By detecting a small amount of ammonia gas, the state of spoilage of the preserved food can be detected. The ammonia detection sheet of the present embodiment is installed, for example, in a detection portion of a sealed container having a transparent portion. A sample of urine or sweat to be detected is injected into the collection part of the sealed container, and the container is sealed. Ammonia contained in urine or sweat is confirmed by observing the change in color tone of the ammonia detection sheet and detecting ammonia gas generated from the specimen, leading to early detection of diseases such as pyelonephritis, cystitis, urethritis, and prostatitis. Furthermore, by using the ammonia detection material of the present invention, liquid ammonia and ammonia in a solvent can also be detected.

### EXAMPLE

Although the present invention will be described below with reference to more detailed embodiments, the present invention is not limited to these embodiments.

### Example 1

(Manufacture of Ammonia Detection Materials)

0.45 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt solution using a separation funnel over 1 hour. After completion of the dropping, the mixture was stirred overnight using a magnetic stirrer. Pink crystals were obtained by filtering and washing the precipitated particles with pure water and vacuum drying the particles on the recovered paper for 5 hours. The ammonia detection material A shown in Table 1 was obtained.

The composition of the detection material of this embodiment was confirmed by ICP optical emission spectrometry, carbon sulfur analysis, and oxygen nitrogen hydrogen analysis. The amount of H₂O contained in the detection material of the present embodiment was determined by confirming the mass number of the gas generated when the temperature was raised using a gas chromatograph mass spectrometer equipped with a double-shot pyrolyzer, and further by confirming the amount of weight reduction using thermogravimetric analysis. The results are shown in Table 1.

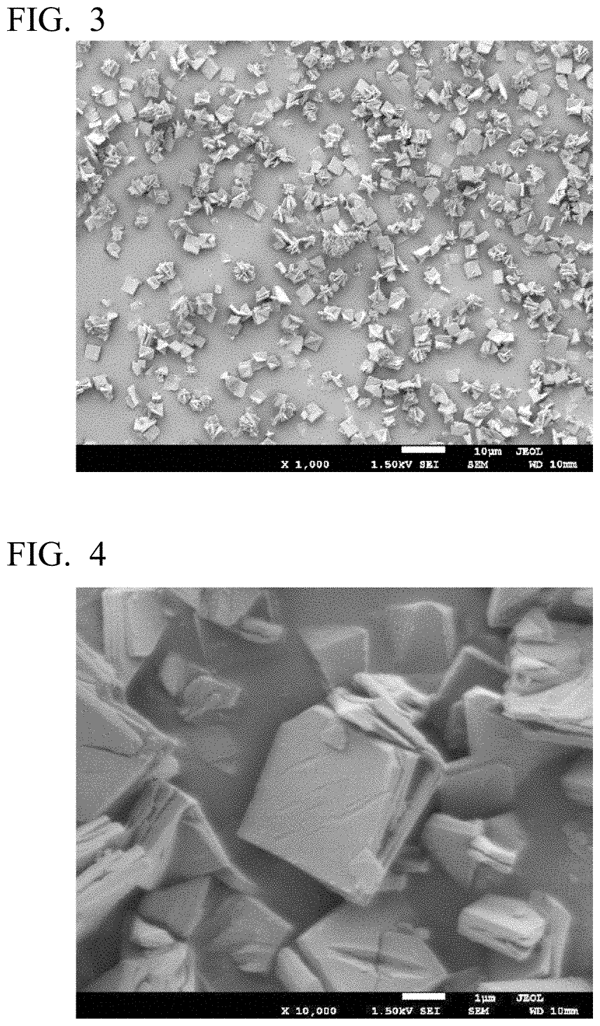

According to the scanning electron microscopy, a plate-shaped crystal having an average length of about 2.5 μm in the long axis direction, an average length of about 2.5 μm in the short axis direction and an average thickness of about 0.25 μm (FIGS. 3 and 4) was confirmed (FIGS. 3 and 4). The crystal form was confirmed by an optical microscope and a scanning electron microscope. The results are shown in Table 1.

The spin state was confirmed using a superconducting quantum interference fluxmeter (SQUID).

(Preparation of Ammonia Detection Sheet)

50 mg of the obtained ammonia detection material A and 100 mg of acrylic binder powder (Boncoat solids, manufactured by DIC) as a binder component were added to 50 ml of acetonitrile to obtain a dispersion containing the ammonia detection material. The nonwoven fabric (FP 7020, manufactured by Wintech) was repeatedly spray-coated with the obtained dispersion so that the loading amount of the ammonia detection material was 0.25 mg/cm², and then dried in an oven at 30° C. to prepare the ammonia detection sheet of this example. When the amount of the binder of the obtained ammonia detection sheet was determined by the above-described method, the amount of the binder was 4% by weight with respect to the weight of the ammonia detection sheet.

(Detection of Ammonia Gas)

A small fan and an ammonia detection sheet were placed in a 5-liter Tedlar bag, which was filled with air containing ammonia gas at a concentration of 40 ppm. The color change of the ammonia detection sheet was confirmed, and the detection part of the ammonia detection sheet changed to yellow. The color change was visually confirmed by comparing it with a color sample. On the other hand, when air containing no ammonia gas was filled, the color of the detection part did not change and the difference in color tone could not be confirmed. As a result, it was confirmed that ammonia gas could be detected by color change.

<Gas Detection Performance>

The gas detection performance was evaluated by measuring the time required for the color tone change of the ammonia detection sheet due to the adsorption of ammonia gas (viewing time). When the color tone change can be detected in less than 45 seconds, the gas detection performance was set to “A”; when the color tone change can be detected in less than 1 minute, the gas detection performance was set to “B”; and when the color tone change can be detected in 1 minute or more and less than 3 minutes, the gas detection performance was set to “C”. When the detection takes 3 minutes or more, the gas detection performance was set to “D”. The results are shown in Table 1.

<Gas Holding Ability>

The gas holding ability was evaluated by measuring the time required for the color tone change of the ammonia detection sheet due to the desorption of ammonia gas (holding time). When the detection sheet after adsorbing ammonia gas was exposed to the atmosphere, if the color change took 3 minutes or more, the gas holding ability was set to “B”; if the color change took 1 minute or more and less than 3 minutes, the gas holding ability was set to “C”; and if the color change took less than 1 minute, the gas holding ability was set to “D”. The results are shown in Table 1.

(Detection of Other Gases)

In place of ammonia gas, ethylene, propylene, toluene, xylene, acetone, ethyl acetate, methanol, ethanol, water, hexane, cyclohexane, chloroform, dimethylamine, trimethylamine, triethylamine, formaldehyde, acetaldehyde, benzoic acid, methyl benzoate, iodine, diethyl ether, dimethyl carbonate, or ethylmethyl carbonate were used to confirm the color change of the ammonia detection sheet, but no change was observed in the detection section of the ammonia detection sheet.

<Gas Selectivity>

The detection performance of the other gas was evaluated in the same manner as the ammonia gas detection performance except that the air containing the other gas was used instead of the air containing the ammonia gas. When no color change was observed even when the concentration of each of the 23 other gases listed above was 40 ppm, the selectivity was set to “B”. When a color change was observed in 1 to 10 of the 23 kinds listed above, the selectivity was set to “C”. When color changes were observed in 11 species or more, selectivity was set to “D”. The results are shown in Table 1.

<Visibility>

When the air containing 40 ppm ammonia gas was detected, the color change before and after ammonia detection was measured using a color difference meter (Type SC-T) manufactured by Suga Test Instruments Co., Ltd. Based on JIS Z 8701, the xy coordinates of 2 points on the xy chromaticity diagram were measured for each color before and after ammonia detection, and the magnitude ΔE of the vector component consisting of the 2 points was obtained using the xy coordinates. The visibility was evaluated by the ΔE values obtained. When ΔE was 0.35 or more, the visibility is set to “A”; and when ΔE was less than 0.35 and 0.15 or more, the visibility was set to “B”. The results are shown in Table 1.

### Example 2

0.45 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt solution using a separation funnel over 1 hour. After completion of the dropping, the mixture was stirred overnight using a magnetic stirrer. The precipitated particles were filtered and washed with pure water, and collected after vacuum drying for 5 hours. And then, 0.1 g of the obtained particles were dispersed in ethanol, and 0.1 g of pyrazine was introduced. After stirring for 1 hour, the precipitates were filtered and dried in vacuum for 1.5 hours to obtain a flesh-colored ammonia detection material. The ammonia detection material B shown in Table 1 was obtained.

An ammonia detection sheet was prepared in the same manner as in Example 1 except that ammonia detection material B was used.

The ammonia detection material B and the ammonia detection sheet were evaluated in the same manner as in Example 1, and the results are shown in Table 1.

### Example 3

0.45 g of copper (II) sulfate pentahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the copper solution using a separation funnel over 1 hour. After completion of the dropping, the mixture was stirred overnight using a magnetic stirrer. The precipitated particles were filtered and washed with pure water, and dried in vacuum for 5 hours to obtain light green crystals. The ammonia detection material C shown in Table 1 was obtained.

An ammonia detection sheet was prepared in the same manner as in Example 1 except that the ammonia detection material C was used.

The ammonia detection material C and the ammonia detection sheet are evaluated in the same manner as in Example 1, and the results are shown in Table 1.

### Example 4

0.45 g of copper (II) sulfate pentahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the copper solution using a separation funnel over 1 hour. After completion of the dropping, the mixture was stirred overnight using a magnetic stirrer. The precipitated particles were filtered and washed with pure water, and collected after vacuum drying for 5 hours. And then, 0.1 g of the obtained particles were dispersed in ethanol, and 0.1 g of pyrazine was introduced. After stirring for 1 hour, the precipitates were filtered and dried in vacuum for 1.5 hours to obtain a yellow-green ammonia detection material. The ammonia detection material D shown in Table 1 was obtained.

An ammonia detection sheet was prepared in the same manner as in Example 1 except that the ammonia detection material D was used.

The ammonia detection material D and the ammonia detection sheet are evaluated in the same manner as in Example 1, and the results are shown in Table 1.

### Example 5

5.47 g of cobalt (II) chloride-hexahydrate was placed and dissolved in an Erlenmeyer flask containing 100 mL of distilled water at room temperature. Further, 5.96 g of potassium tetracyanonickelate (II) monohydrate was placed and dissolved in an Erlenmeyer flask containing 100 mL of distilled water at room temperature. The tetracyanonickel solution was charged into the cobalt solution and stirred with a magnetic stirrer for 1 hour. The precipitated particles were filtered and washed with pure water, and dried in vacuum for 5 hours to obtain pink crystals. The ammonia detection material E shown in Table 1 was obtained.

An ammonia detection sheet was prepared in the same manner as in Example 1 except that ammonia detection material E was used.

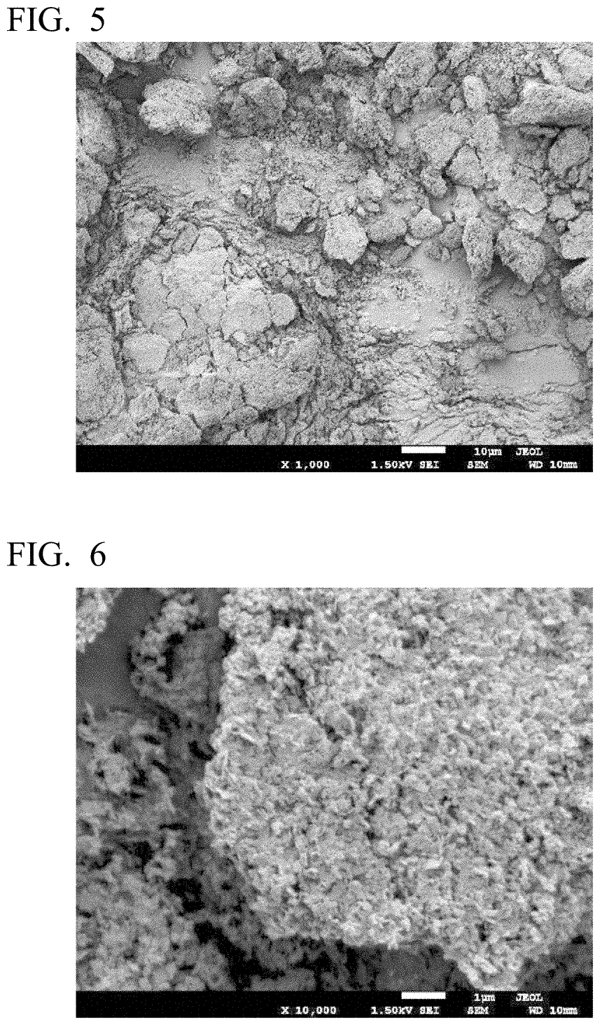

The ammonia detection material E and the ammonia detection sheet are evaluated in the same manner as in Example 1, and the results are shown in Table 1 and FIGS. 5 and 6.

### Example 6

A metal complex was prepared in the same manner as in Example 1 except that the particles on the recovered paper were dried in an oven at 35° C. for 1 hour, whereby pink crystals were obtained. The ammonia detection material F shown in Table 1 was obtained.

An ammonia detection sheet was prepared in the same manner as in Example 1 except that the ammonia detection material F was used.

The ammonia detection material F and the ammonia detection sheet are evaluated in the same manner as in Example 1, and the results are shown in Table 1.

### Example 7

A metal complex was prepared in the same manner as in Example 1 except that the particles on the recovered filter paper were dried in an oven at 100° C. for 1 hour, whereby indigo blue crystals were obtained. The ammonia detection material G was obtained.

An ammonia detection sheet was prepared in the same manner as in Example 1 except that the ammonia detection material G was used.

The ammonia detection material G and the ammonia detection sheet are evaluated in the same manner as in Example 1, and the results are shown in Table 1.

### Example 8

0.41 g of cobalt (II) chloride-hexahydrate, 0.07 g of ammonium iron (II) sulfate-hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt-iron solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material H shown in Table 1 was obtained.

An ammonia detection sheet was prepared in the same manner as in Example 1 except that the ammonia detection material H was used.

The ammonia detection material H and the ammonia detection sheet are evaluated in the same manner as in Example 1, and the results are shown in Table 1.

### Example 9

0.36 g of cobalt (II) chloride-hexahydrate, 0.15 g of ammonium iron (II) sulfate-hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt-iron solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material I shown in Table 1 was obtained.

An ammonia detection sheet was prepared in the same manner as in Example 1 except that the ammonia detection material 1 was used.

The ammonia detection material I and the ammonia detection sheet are evaluated in the same manner as in Example 1, and the results are shown in Table 1.

### Example 10

0.32 g of cobalt (II) chloride-hexahydrate, 0.31 g of copper (II) sulfate-pentahydrate and 0.32 g of L-ascorbic acid were placed and dissolved in an Erlenmeyer flask containing 360 mL of distilled water at a room temperature and a mixed solvent of ethanol. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt copper solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material J shown in Table 1 was obtained.

An ammonia detection sheet was prepared in the same manner as in Example 1 except that the ammonia detection material J was used.

The ammonia detection material J and the ammonia detection sheet are evaluated in the same manner as in Example 1, and the results are shown in Table 1.

### Example 11

A metal complex was prepared in the same manner as in Example 1 except that the particles on the recovered filter paper were dried in an oven at 70° C. for 1 hour, whereby indigo blue crystals were obtained. The ammonia detection material K was obtained.

An ammonia detection sheet was prepared in the same manner as in Example 1 except that the ammonia detection material K was used.

The ammonia detection material K and the ammonia detection sheet were evaluated in the same manner as in Example 1, and the results are shown in Table 1.

### Example 12

0.47 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material L shown in Table 1 was obtained.

An ammonia detection sheet was prepared in the same manner as in Example 1 except that the ammonia detection material L was used.

The ammonia detection material L and the ammonia detection sheet were evaluated in the same manner as in Example 1, and the results are shown in Table 1.

### Example 13

A metal complex was prepared in the same manner as in Example 1 except that the particles on the recovered paper were dried in an oven at 40° C. for 1 hour, whereby pink crystals were obtained. The ammonia detection material M shown in Table 2 was obtained.

An ammonia detection sheet was prepared in the same manner as in Example 1 except that the ammonia detection material M was used.

The ammonia detection material M and the ammonia detection sheet were evaluated in the same manner as in Example 1, and the results are shown in Table 2.

### Example 14

0.45 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.41 g of potassium tetracyanonickelate (II) monohydrate and 0.05 g of potassium tetracyanopalladium (II) monohydrate were placed and dissolved in an Erlenmeyer flask containing 360 mL of a mixed solvent of distilled water and ethanol at room temperature. The tetracyanonicker-containing solution was added dropwise to the cobalt solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material N shown in Table 2 was obtained.

An ammonia detection sheet was prepared in the same manner as in Example 1 except that the ammonia detection material N was used.

The ammonia detection material N and the ammonia detection sheet were evaluated in the same manner as in Example 1, and the results are shown in Table 2.

### Example 15

0.45 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.41 g of potassium tetracyanonickelate (II) monohydrate and 0.07 g of potassium tetracyanoplatinate (II) monohydrate were placed and dissolved in an Erlenmeyer flask containing 360 mL of a mixed solvent of distilled water and ethanol at room temperature. The tetracyanonicker-containing solution was added dropwise to the cobalt solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material O shown in Table 2 was obtained.

An ammonia detection sheet was prepared in the same manner as in Example 1 except that the ammonia detection material O was used.

The ammonia detection material O and the ammonia detection sheet were evaluated in the same manner as in Example 1, and the results are shown in Table 2.

### Example 16

A metal complex was prepared in the same manner as in Example 1 except that the particles on the recovered filter paper were dried in an oven at 60° C. for 1 hour, whereby purple crystals were obtained. The ammonia detection material P was obtained.

An ammonia detection sheet was prepared in the same manner as in Example 1 except that the ammonia detection material P was used.

The ammonia detection material P and the ammonia detection sheet are evaluated in the same manner as in Example 1, and the results are shown in Table 2.

### Example 17

A metal complex was prepared in the same manner as in Example 1 except that the particles on the recovered filter paper were dried in an oven at 65° C. for 1 hour, whereby purple crystals were obtained. The ammonia detection material Q was obtained.

An ammonia detection sheet was prepared in the same manner as in Example 1 except that the ammonia detection material Q was used.

The ammonia detection material Q and the ammonia detection sheet were evaluated in the same manner as in Example 1, and the results are shown in Table 2.

### Example 18

0.45 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.41 g of potassium tetracyanonickelate (II) monohydrate and 0.05 g of potassium tetracyanopalladium (II) monohydrate were placed and dissolved in an Erlenmeyer flask containing 360 mL of a mixed solvent of distilled water and ethanol at room temperature. The tetracyanonicker-containing solution was added dropwise to the cobalt solution using a separation funnel over 1 hour. After completion of the dropping, the mixture was stirred overnight using a magnetic stirrer. The precipitated particles were filtered and washed with pure water, and collected after vacuum drying for 5 hours. And then, 0.1 g of the obtained particles were dispersed in ethanol, and 0.1 g of pyrazine was introduced. After stirring for 1 hour, the precipitates were filtered and dried in vacuum for 1.5 hours to obtain a flesh-colored ammonia detection material. The ammonia detection material R shown in Table 2 was obtained.

An ammonia detection sheet was prepared in the same manner as in Example 1 except that the ammonia detection material R was used.

The ammonia detection material R and the ammonia detection sheet were evaluated in the same manner as in Example 1, and the results are shown in Table 2.

### Example 19

0.45 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.41 g of potassium tetracyanonickelate (II) monohydrate and 0.05 g of potassium tetracyanoplatinate (II) monohydrate were placed and dissolved in an Erlenmeyer flask containing 360 mL of a mixed solvent of distilled water and ethanol at room temperature. The tetracyanonicker-containing solution was added dropwise to the cobalt solution using a separation funnel over 1 hour. After completion of the dropping, the mixture was stirred overnight using a magnetic stirrer. The precipitated particles were filtered and washed with pure water, and collected after vacuum drying for 5 hours. 0.1 g of the obtained particles were dispersed in ethanol, and 0.1 g of pyrazine was introduced. After stirring for 1 hour, the precipitates were filtered and dried in vacuum for 1.5 hours to obtain a flesh-colored ammonia detection material. The ammonia detection material S shown in Table 2 was obtained.

An ammonia detection sheet was prepared in the same manner as in Example 1 except that the ammonia detection material S was used.

The ammonia detection material S and the ammonia detection sheet were evaluated in the same manner as in Example 1, and the results are shown in Table 2.

### Example 20

0.36 g of cobalt (II) chloride hexahydrate, 0.05 g of copper (II) sulfate pentahydrate, 0.07 g of ammonium iron (II) sulfate hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt-iron solution using a separation funnel over 1 hour. After completion of the dropping, the mixture was stirred overnight using a magnetic stirrer. The precipitated particles were filtered with pure water, washed, and dried in vacuum for 5 hours to obtain pink crystals. The ammonia detection material T shown in Table 2 was obtained.

An ammonia detection sheet was prepared in the same manner as in Example 1 except that an ammonia detection material T was used.

The ammonia detection material T and the ammonia detection sheet were evaluated in the same manner as in Example 1, and the results are shown in Table 2.

### Comparative Example 1

0.14 g of cobalt (II) chloride hexahydrate, 0.52 g of ammonium iron (II) sulfate hexahydrate, 0.32 g of L-ascorbic acid, 0.45 g of potassium tetracyanonickelate (II) monohydrate, and 0.15 g of pyrazine were placed and dissolved in an Erlenmeyer flask containing 360 mL of a mixed solvent of distilled water and ethanol at room temperature. After dissolution, the precipitated particles, which were stirred overnight using a magnetic stirrer, were filtered and washed using pure water, and dried in vacuum for 5 hours to obtain red-purple crystals. The ammonia detection material U shown in Table 2 was obtained.

An ammonia detection sheet was prepared in the same manner as in Example 1 except that the ammonia detection material U was used.

The ammonia detection material U and the ammonia detection sheet were evaluated in the same manner as in Example 1, and the results are shown in Table 2.

### Comparative Example 2

0.50 g of cobalt (II) chloride-hexahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the cobalt solution using a separation funnel over 1 hour. After completion of the dropping, the mixture was stirred overnight using a magnetic stirrer. The precipitated particles were filtered and washed with pure water, and dried in vacuum for 5 hours to obtain pink crystals. The ammonia detection material V shown in Table 2 was obtained.

An ammonia detection sheet was prepared in the same manner as in Example 1 except that the ammonia detection material V was used.

The ammonia detection material V and the ammonia detection sheet were evaluated in the same manner as in Example 1, and the results are shown in Table 2.

### Comparative Example 3

0.50 g of copper (II) sulfate pentahydrate and 0.32 g of L-ascorbic acid were placed and dissolved in an Erlenmeyer flask containing 360 mL of a mixed solvent of distilled water and ethanol at room temperature. Further, 0.45 g of potassium tetracyanonickelate (II) monohydrate was placed and dissolved in an Erlenmeyer flask containing 360 mL of a mixed solvent of distilled water and ethanol at room temperature. The tetracyanonickel solution was added dropwise to the copper solution using a separation funnel over 1 hour. After completion of the dropping, the mixture was stirred overnight using a magnetic stirrer. The precipitated particles were filtered and washed with pure water, and collected after vacuum drying for 5 hours. And then, 0.1 g of the obtained particles were dispersed in ethanol, and 0.1 g of pyrazine was introduced. After stirring for 1 hour, the precipitates were filtered and dried in vacuum for 1.5 hours to obtain a yellow-green ammonia detection material. The ammonia detection material W shown in Table 2 was obtained.

An ammonia detection sheet was prepared in the same manner as in Example 1 except that the ammonia detection material W was used.

The ammonia detection material W and the ammonia detection sheet were evaluated in the same manner as in Example 1, and the results are shown in Table 2.

TABLE 1

| | Ammonia | | Particle Shape | Gas | | | |
|---|---|---|---|---|---|---|---|
| | Detection | Metal Complex | And Size | Detection | Holding | | Color Tone Change |
| | Material | Composition | (L × W × T, μm) | Performance | Ability | Selectivity | And Visibility |
| Example 1 | A | Co[Ni(CN)₄]•2.7H₂O | Plate | B | B | B | Pink → Yellow |
| | | | 2.5 × 2.5 × 0.25 | | | | B |
| Example 2 | B | Co(pz)[Ni(CN)₄] | Plate | B | B | B | Pale Orange → Ocher |
| | | | 4 × 4 × 0.5 | | | | B |
| Example 3 | C | Cu[Ni(CN)₄]•3.0H₂O | Plate | C | B | B | Light Green → Light |
| | | | 0.5 × 0.5 × 0.2 | | | | Blue |
| | | | | | | | B |
| Example 4 | D | Cu(pz)[Ni(CN)₄] | Plate | C | B | B | Yellow-Green → Blue |
| | | | 1.0 × 1.0 × 0.5 | | | | B |
| Example 5 | E | Co[Ni(CN)₄]•3.0H₂O | Irregular Shape | C | C | B | Pink → Yellow |
| | | | | | | | B |
| Example 6 | F | Co[Ni(CN)₄]•6.0H₂O | Plate | C | C | B | Pink → Yellow |
| | | | 2.5 × 2.5 × 0.25 | | | | B |
| Example 7 | G | Co[(Ni(CN)₄] | Plate | C | B | B | Indigo → Yellow |
| | | | 2.5 × 2.5 × 0.25 | | | | A |
| Example 8 | H | Co_{0.9}Fe_{0.1}[Ni(CN)₄]•3.2H₂O | Plate | B | B | B | Pink → Yellow |
| | | | 2.7 × 2.7 × 0.25 | | | | B |
| Example 9 | I | Co_{0.8}Fe_{0.2}[Ni(CN)₄]•3.2H₂O | Plate | C | C | B | Pink → Yellow |
| | | | 3 × 3 × 0.25 | | | | B |
| Example 10 | J | Co_{0.7}Cu_{0.3}[Ni(CN)₄]•3.0H₂O | Plate | B | B | B | Pink → Yellow |
| | | | 2.3 × 2.3 × 0.25 | | | | B |
| Example 11 | K | Co[Ni(CN)4]•0.6H₂O | Plate | B | B | B | Indigo → Yellow |
| | | | 2.5 × 2.5 × 0.25 | | | | A |
| Example 12 | L | Co_{1.05}[Ni(CN)₄]•3H₂O | Plate | B | C | B | Pink → Yellow |
| | | | 2.5 × 2.5 × 0.25 | | | | B |

TABLE 2

| | Ammonia | | Particle Shape | Gas | | | |
|---|---|---|---|---|---|---|---|
| | Detection | Metal Complex | And Size | Detection | Holding | | Color Tone Change |
| | Material | Composition | (L × W × T, μm) | Performance | Ability | Selectivity | And Visibility |
| Example 13 | M | Co[Ni(CN)₄]•5.8H₂O | Plate | B | B | B | Pink → Yellow |
| | | | 2.5 × 2.5 × 0.25 | | | | B |
| Example 14 | N | Co[Ni_{0.9}Pd_{0.1}(CN)₄]•H₂O | Plate | B | B | B | Pink → Yellow |
| | | | 2.5 × 2.5 × 0.2 | | | | B |
| Example 15 | O | Co[Ni_{0.9}Pt_{0.1}(CN)₄]•3H₂O | Plate | B | B | B | Pink → Yellow |
| | | | 2.5 × 2.5 × 0.2 | | | | B |
| Example 16 | P | Co[Ni(CN)₄]•2.5H₂O | Plate | A | C | C | Purple → Yellow |
| | | | 2.5 × 2.5 × 0.25 | | | | A |
| Example 17 | Q | Co[Ni(CN)₄]•1.5H₂O | Plate | A | C | C | Purple → Yellow |
| | | | 2.5 × 2.5 × 0.25 | | | | A |
| Example 18 | R | Co(pz)[Ni_{0.9}Pd_{0.1}(CN)₄] | Plate | B | B | B | Skin → Ocher |
| | | | 2.5 × 2.5 × 0.2 | | | | B |
| Example 19 | S | Co(pz)[Ni_{0.9}Pt_{0.1}(CN)₄] | Plate | B | B | B | Skin → Ocher |
| | | | 2.5 × 2.5 × 0.2 | | | | B |
| Example 20 | T | Co_{0.8}Cu_{0.1}Fe_{0.1}[Ni(CN)₄]•3.2H₂O | Plate | B | B | B | Pink → Yellow |
| | | | 2.5 × 2.5 × 0.2 | | | | B |
| Comparative | U | Co_{0.3}Fe_{0.7}(pz)[Ni(CN)₄] | Irregular Shape | B | B | D | Magenta → Orange |
| Example 1 | | | | | | | |
| Comparative | V | Co_{1.1}[Ni(CN)₄]•3H₂O | Plate | C | D | C | Pink → Yellow |
| Example 2 | | | 2.5 × 2.5 × 0.25 | | | | B |
| Comparative | W | Cu_{1.1}(pz)[Ni(CN)₄] | Plate | D | C | C | Yellow-Green → Blue |
| Example 3 | | | 0.8 × 0.8 × 0.4 | | | | B |

From the above results, the ammonia detection sheet (detector) including the ammonia detection material and the ammonia detection material of the embodiment can detect ammonia easily, sensitively, continuously and selectively.

### SIGN DESCRIPTION

1, 10: Ammonia Detection Material
2, 12: Metal M ion, Co ion
3, 13: Tetracyanonickelate Ion
4, 14: Pyrazine

What is claimed is:

1. An ammonia detection material, which is represented by general formula (1),
M1ₓFe_{y}(Pyrazine)ₛ[Ni₁₋ₜM2ₜ(CN)₄]zH₂O (1)
wherein M1=Co, Cu; 0.6≤x≤1.05; 0≤y≤0.4; 0≤s≤1; M2=Pd, Pt; 0≤t<0.15; 0≤z≤6.

2. The ammonia detection material according to claim 1, wherein the ammonia detection material is represented by general formula (2),
Coₓ[Ni₁₋ₜM2ₜ(CN)₄].zH₂O (2)
wherein 0.9≤x≤1.0; M2=Pd, Pt; 0≤t<0.15; 0.5≤z<6.

3. The ammonia detection material according to claim 1, wherein the ammonia detection material is a polygonal plate-shaped metal complex particle having a side length of 0.5 μm or more and a thickness of 0.2 μm or more.

4. A detector comprising the ammonia detection material of claim 1.

5. The ammonia detection method, comprising detecting ammonia by using the ammonia detection material according to claim 1.
